(19) United States
(12) Patent Application Publication
(10) Pub. No.: US 2006/0143069 A1
(43) Pub. Date: Jun. 29, 2006

(54) Method of designing a desirable customer experience

(76) Inventors: Rick Graves, Rocklin, CA (US); Michael J. Calistro, Loveland, CO (US); Maryline Labourier, Lyon (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/025,545

(22) Filed: Dec. 28, 2004

(51) Int. Cl. G06F 17/30

(52) U.S. Cl. 705/10

(57) ABSTRACT

A method of designing a desirable customer experience is disclosed. The method includes identifying a target customer. Also, the method includes determining the desirable customer experience. In determining the desirable customer experience, the desires of the target customer are identified at each stage of a customer lifecycle, wherein each stage of the customer lifecycle affects the desirable customer experience. Further, in determining the desirable customer experience, interactions with the target customer that meet the desires of the target customer are determined. Continuing, in determining the desirable customer experience, the manner of staying aware of success of the desirable customer experience is determined. Furthermore, the method includes selecting portions of the determined desirable customer experience to implement based on information including feasibility of changes to deliver aspects of the determined desirable customer experience and prioritization of aspects of the determined desirable customer experience.

### BACKGROUND OF THE INVENTION

1. Field of the Invention

The present invention generally relates to customer experiences. More particularly, the present invention relates to designing a desirable customer experience.

2. Related Art

Organizations (e.g., businesses, governments, etc,) that deal with customers spend significant resources in providing services, products, solutions, or processes to their customers. Consultants and other third-parties are hired to educate the organizations about being more effective and efficient. Due to cost and time constraints, these consultants and other third-parties are able to educate only a portion of an organization. Generally, these consultants and other third-parties have expertise to deal with the problems they have been hired to address. On some occasions, a random selection of individuals from the organization is the audience for these consultants and other third-parties. Thus, the knowledge of these consultants and other third-parties typically is not extended across the organization. Further, this knowledge may not be applicable to all portions of the organization because of problem-specific aspects of this knowledge.

In a great number of instances, these organizations first design the perfect service, product, solution, or process, using the organization's point of view as the dominant factor. These organizations assume they know what is best for their customers. Then, they seek the perfect customers in order to provide them this perfect service, product, solution, or process. If their pool of perfect customers is not sufficiently large, the perfect service, product, solution, or process will not be a success. Even if the pool of customers is expanded, there is no guarantee that the perfect service, product, solution, or process will be any more successful.

This conventional paradigm leads to several problems. Relations between organizations and customers are negatively affected. Further, customer experiences with the different portions of the same organization vary dramatically.

### SUMMARY OF THE INVENTION

A method of designing a desirable customer experience is disclosed. The method includes identifying a target customer. Also, the method includes determining the desirable customer experience. In determining the desirable customer experience, the desires of the target customer are identified at each stage of a customer lifecycle, wherein each stage of the customer lifecycle affects the desirable customer experience. Further, in determining the desirable customer experience, interactions with the target customer that meet the desires of the target customer are determined. Continuing, in determining the desirable customer experience, the manner of staying aware of success of the desirable customer experience is determined. Furthermore, the method includes selecting portions of the determined desirable customer experience to implement based on information including feasibility of changes to deliver aspects of the determined desirable customer experience and prioritization of aspects of the determined desirable customer experience.

### BRIEF DESCRIPTION OF THE DRAWINGS

The accompanying drawings, which are incorporated in and form a part of this specification, illustrate embodiments of the invention and, together with the description, serve to explain the principles of the present invention.

FIG. 1 illustrates a flow chart showing a method of designing a desirable customer experience in accordance with an embodiment of the present invention.

FIG. 2 illustrates a customer data packet in accordance with an embodiment of the present invention.

FIG. 3 illustrates a customer lifecycle template in accordance with an embodiment of the present invention.

### DETAILED DESCRIPTION OF THE INVENTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention.

A structured methodology is provided for designing customer experiences. The structured methodology can be utilized quickly, pervasively, and in a cost effective manner across organizations. It provides an accelerated method that insures customer experiences are defined and delivered quickly in an efficient and effective manner. In an embodiment, this structured methodology may be presented to and utilized by groups of individuals of an organization in a 2-3 day workshop. Further, the structured methodology may be customized and refined, as needed.

This structured methodology takes the customer's point of view instead of the organization's (e.g., business', government's, etc,) point of view. Focus is on identifying and understanding the customer sufficiently well. If the customer is identified and understood, the customer experience desired by the customer can be delivered. That is, if the organization starts the design of a service, product, solution, or process by identifying and understanding the customers well, a desirable customer experience can then be designed. Thereafter, the service, product, solution, or process can be designed to meet the desirable customer experience. As a result, the service, product, solution, or process is likely to be a success.

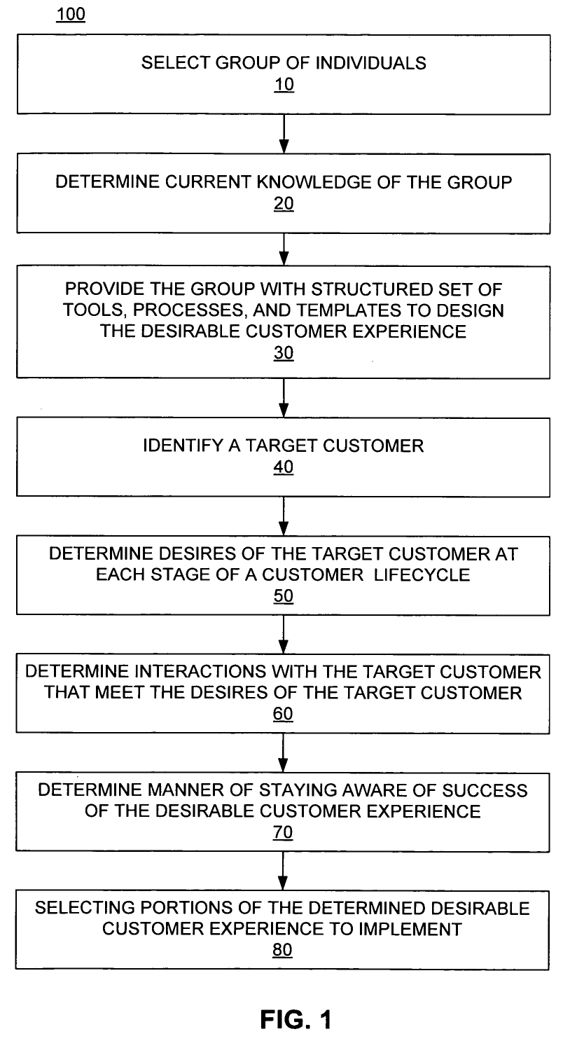

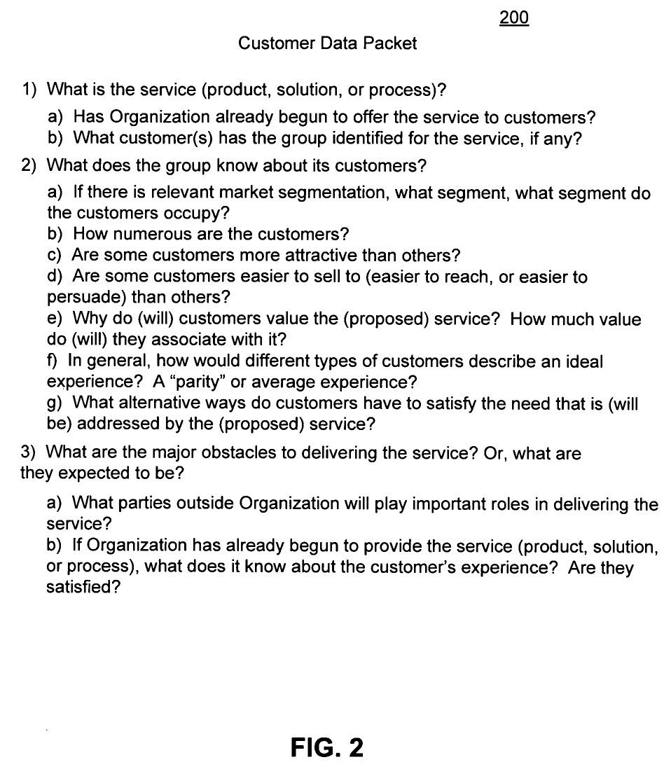

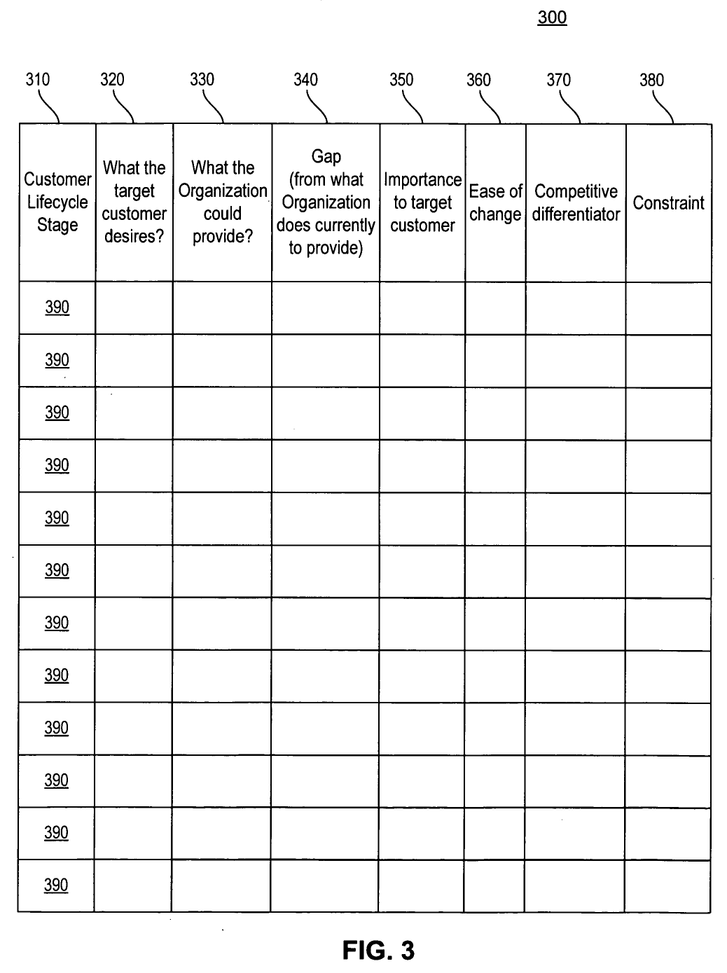

FIG. 1 illustrates a flow chart showing a method 100 of designing a desirable customer experience in accordance with an embodiment of the present invention. Reference is made to FIGS. 2 and 3.

At 10, a group of individuals is selected to design a desirable customer experience. Composition of this group influences success in designing the desirable customer experience. Rather than being a random collection of individuals, this group includes individuals representing each stage of a customer lifecycle, promoting cross-collaboration. The group further includes experience and expertise concerning customers and customer interactions with the organization. Each stage of the customer lifecycle is a touch point with the customer that affects directly or indirectly the customer's experience with the organization. That is, each stage of the customer lifecycle affects design of the overall desirable customer experience. A critical encompassing element of the customer lifecycle is relationship, and this may be impacted during the customer experience, throughout the customer lifecycle. In addition, the customer may have a desired experience around relationship that may not be covered by one individual phase of the customer lifecycle. These desires and expectations would be captured in the relationship subject matter of CED (Customer Experience Design) worksheets such the customer data packet 200 of FIG. 2 and the customer lifecycle template 300 of FIG. 3.

In an embodiment, the customer lifecycle comprises awareness, choosing, ordering, installing, learning, using, support/service, and disposing/upgrading. The awareness stage encompasses customer activities such as engaging the organization, accessing information of the organization, comparing alternatives, and developing relationship with the organization. The choosing stage refers to customer activities such as engaging with the right resources of the organization, obtaining and understanding offers from the organization, configuring a service, product, solution, or process from the organization, and technically evaluating the organization's services, products, solutions, and processes.

Further, the ordering stage comprises customer activities such as getting a quote, getting a purchase approval, placing an order, and tracking an order. The installing stage includes customer activities such as setting-up and time to first use, and getting startup assistance. The learning stage encompasses customer activities such as training customer's people, using resources by customer's people, and identifying and accessing the right resources. The using stage refers to customer activities such as getting assistance; maintaining, enhancing, and performance tuning resources; measuring value-adds; and understanding the support process. The support/service stage comprises customer activities such as resolving problems, understanding the support process, identifying customer's equipment and entitlement, and resolving contracts and issues. Furthermore, the disposing/upgrading stage includes customer activities such as partriering with organization to help plan for hardware and software improvements, upgrades, recommended replacements for obsolescence, and responsible disposals.

Continuing at 20, the current knowledge of the group with respect to the desirable customer experience is determined. In an embodiment, the group answers questions in a customer data packet submitted to the group before initiating the design of the desirable customer experience. FIG. 2 illustrates a customer data packet 200 in accordance with an embodiment of the present invention. The customer data packet 200 includes questions that facilitate group composition and customer identification. Here, the customer data packet 200 is adapted for services to be designed to meet the desirable customer experience. Also, these questions are utilized to maintain proper scope and focus during design of the desirable customer experience. It should be understood that the customer data packet 200 may be adapted for products, solutions, and processes to be designed to meet the desirable customer experience.

Moreover, at 30, the group is provided a structured set of tools, processes, and templates to use in designing the desirable customer experience, as will be described below. In an embodiment, this is the beginning of a 2-3 day workshop. The structured set of tools, processes, and templates is customized based on the current knowledge of the group obtained from the customer data packet 200. Further, the structured set of tools, processes, and templates represent a customer experience design technique that takes the point of view of the customer and focuses on understanding the customer.

At 40, the group identifies and defines a target customer. This involves gaining insight into customers and understanding why customers want what they want. If the target customer is sufficiently understood, the behavior of the target customer can be predicted at each stage of the customer lifecycle. Tools and processes such as guiding questions and the customer data packet 200 assist the group with this task. Examples of the guiding questions include: Who are the customers the group has current or planned contact with?; What are the roles and responsibilities of the target customer?; What is the work environment of the target customer?; What is any relevant personal information of the target customer?; What motivates the target customer?; and is the target customer motivated by product quality, brand name, post-sales support, installation, cost of ownership, pre-sales support, ordering, delivery, or communication?

If several types of customers are identified, these several types of customers are prioritized to select the target customer. If the target customer is defined too vaguely, it is difficult to gain insight into the target customer and understand why the target customer wants what he/she wants. Generally, the more specific the target customer, the better the insight into the target customer and the understanding why the target customer wants what he/she wants. Sources of information about customers include personal experience with customers, customer focus groups, analysis of customer complaints, analysis of attributes that competitors stress in marketing efforts, the sales force, and syndicated research data.

Still referring to FIG. 1, at 50, the group determines the desires of the target customer at each stage of the customer lifecycle (e.g., awareness, choosing, ordering, installing, learning, using, support/service, and disposing/upgrading) or (ACOILUSD). Each stage of the customer lifecycle affects the design of the desirable customer experience. Tools and processes such as guiding questions, the customer data packet 200, and the “5 Why Technique” assist the group with this task. Examples of the guiding questions include: What does the target customer desire at the awareness, choosing, ordering, installing, learning, using, support/service, and disposing/upgrading stages of the customer lifecycle?; What is the target customer's point of view?; Which desires can be met in the short-term?; Which desires can be met in the long-term?; Which desires can be competitive differentiators with respect to competitors?; and What will the target customer desire in the future?

The “5 Why Technique” enables the group to probe deeply into a topic. The idea is that five iterations of the question will reveal a new level of knowledge about root causes of anything. This allows the group to determine a robust quantity and quality of desires of the target customer at each stage of the customer lifecycle. For example, the question, “Why does the target customer want a particular desire?”, may be the basis for using the “5 Why Technique”.

Furthermore, templates such as customer lifecycle templates also assist the group with the task of determining the desires of the target customer at each stage of the customer lifecycle, as well as structurally organizing the desires. FIG. 3 illustrates a customer lifecycle template 300 in accordance with an embodiment of the present invention. As depicted in FIG. 3, the customer lifecycle template 300 has a plurality of columns 310-380 and a plurality of rows 390. The column 310 is used to indicate a stage of the customer lifecycle (e.g., awareness, choosing, ordering, installing, learning, using, support/service, and disposing/upgrading) or (ACOILUSD). The desires of the target customer are inserted in the column 320. Generally, a separate row 390 is allocated for each desire within a stage of the customer lifecycle. However, multiple desires within a stage may be combined into a single row 390. Some stages will have more desires than other stages, depending on the target customer.

Referring again to FIG. 1, at 60, the group determines interactions between the target customer and the organization that meet the desires of the target customer. That is, for each desire, the group describes in detail how the interaction will occur between the target customer and the organization to meet the desire. Generally, each interaction represents a service, a product, a solution, a process, or any combination thereof to meet the desires of the target customer. Tools, processes, and templates such as guiding questions, the customer data packet 200, and the customer lifecycle template 300 assist the group with this task. As depicted in FIG. 3, the customer lifecycle template 300 has a column 330. The interactions between the target customer and the organization that meet the desires of the target customer are inserted into column 330.

Continuing with FIG. 1, at 70, the group determines the manner of staying aware of the success of the desirable customer experience. Tools, processes, and templates such as guiding questions, the customer data packet 200, and the customer lifecycle template 300 assist the group with this task. Examples of the guiding questions include: How will the organization know that the organization has done what the target customer wants?; How should the organization measure the target customer's satisfaction; Is the organization measuring everything that is important?; What should the organization do with the feedback target customers give to the organization?; How does the organization validate what the organization thinks it knows?; Whether the organization actually gives the target customers the desirable customer experience the organization intended?; How the desirable customer experience that the organization delivers deviates from the one the target customers desire?; and How does the organization compare to and differentiate from competitors?

Moreover, at 80, the group selects portions of the determined desirable customer experience to implement, where the tasks described at 40, 50, 60 and 70 result in the determined desirable customer experience. Tools, processes, and templates such as guiding questions, the customer data packet 200, the customer lifecycle template 300, gap analysis, and the change management grid assist the group with this task. The group prioritizes the desires of the target customer from the target customer's perspective. Higher priority levels are assigned to desires considered more important to the target customers. Lower priority levels are assigned to desires considered less important to the target customers.

Additionally, for each desire, the group determines the gap between the determined desirable customer experience and a current customer experience provided by the organization. The group assesses the organization's ability to implement change to bridge the gap. Higher difficulty levels are assigned to desires having gaps that are harder to implement. Lower difficulty levels are assigned to desires having gaps that are easier to implement. Further, the group identifies desires that are competitive differentiators with respect to competitors and identifies known or potential constraints and limitations in the organization's ability to implement change to bridge the gap.

In an embodiment, the group's selection of portions of the determined desirable customer experience to implement is based on information described above. This information includes the feasibility of changes by the organization to deliver aspects of the determined desirable customer experience as indicated by the difficulty level, prioritization of aspects of the determined desirable customer experience as indicated by the priority level, and competitive differentiator aspects of the determined desirable customer experience. As depicted in FIG. 3, the customer lifecycle template 300 has columns 340-380. The gaps between the determined desirable customer experience and a current customer experience provided by the organization are inserted into column 340. The priority levels assigned to desires are inserted into column 350. The difficulty levels assigned to bridging the gaps of desires are inserted into column 360. Further, whether a desire is a competitive differentiator is indicated in column 370. Moreover, constraints and limitations in the organization's ability to implement change to bridge the gap are inserted in column 380.

After the group has selected portions of the determined desirable customer experience to implement, the group proceeds to develop next steps and action plan to deliver the desirable customer experience that has been designed. In an embodiment, this marks the end of the 2-3 day workshop.

In conclusion, the structured methodology for designing customer experiences has unique characteristics and advantages. It provides a step-by-step approach to facilitate design of customer experiences using associated tools, processes, and templates. Moreover, it facilitates the identification and description of target customers. The structured methodology defines and develops customer experience design content in the context of the customer lifecycle. Further, it provides a foundation for capturing customer experience design content, and associated output in a structured manner (e.g., customer desires, priorities, competitive differentiators, constraints, etc.). Also, this approach can be tailored to meet specific organization and customer issues. Group composition and expertise substantially influences the success of this structured methodology.

Furthermore, customer's needs and desires are identified, defined, and delivered. The link between the customer's experience and organizational activities is identified. Collaboration across the organization is promoted when developing and deploying services, products, solutions, and processes. Relationships and experiences with customers are improved. Gaps in current customer interactions are identified. Organizational initiatives are customer focused and their impact on specific customer interactions are addressed. The link between measures and the customer experience are considered.

Also, the structured methodology helps to create and identify customer experiences that are competitive differentiators with respect to competitors. It helps to create a customer experience vision for the organization over the entire customer lifecycle, insures customer experience designs are defined and delivered in an efficient and effective manner, and provides an accelerated manner to identify and design the customer experience. The structured methodology provides a forum to collaborate with the customer on key issues, improves customer experience design content to discuss and validate with customers, provides a foundation to use for detailed planning, and enables incorporation of customer experience improvements into business plans.

Finally, a unique aspect of the structured methodology is that the designed customer experience is capable of being created, defined, and delivered in a 2-3 day workshop. This is not a “consulting” engagement that takes places over several months and requires the hiring of a 3rd party (e.g., consulting organization, etc.), or a significant amount of investment. It is a very structured way for groups of individuals to accomplish the design of the customer experience in a very short period of time. In addition, the structure, templates, knowledge, and associated materials provided, can be leveraged and used by the groups as they move forward to address other unique customer issues.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of designing a desirable customer experience, said method comprising:
identifying a target customer;
determining said desirable customer experience, wherein said determining includes:
determining desires of said target customer at each stage of a customer lifecycle, wherein each stage of said customer lifecycle affects said desirable customer experience;
determining interactions with said target customer that meet said desires of said target customer; and
determining manner of staying aware of success of said desirable customer experience; and
selecting portions of said determined desirable customer experience to implement based on information including feasibility of changes to deliver aspects of said determined desirable customer experience and prioritization of aspects of said determined desirable customer experience.

2. The method as recited in claim 1 wherein said determining said desirable customer experience further comprises:
taking point of view of said target customer.

3. The method as recited in claim 1 wherein said determining said desirable customer experience further comprises:
focusing on understanding said target customer.

4. The method as recited in claim 1 wherein stages of said customer lifecycle comprise: awareness, choosing, ordering, installing, learning, using, support/service, and disposing/upgrading.

5. The method as recited in claim 1 wherein said information further includes competitive differentiator aspects of said determined desirable customer experience.

6. The method as recited in claim 1 wherein said selecting portions of said determined desirable customer experience comprises:
determining gap between said determined desirable customer experience and a current customer experience.

7. The method as recited in claim 1 wherein said identifying said target customer comprises:
sufficiently understanding said target customer to predict behavior of said target customer.

8. A method of designing desirable customer experiences, said method comprising:
selecting a group of individuals to design a desirable customer experience, wherein said group includes individuals representing each stage of a customer lifecycle, wherein each stage of said customer lifecycle affects said desirable customer experience;
determining current knowledge of said group with respect to said desirable customer experience;
using said current knowledge to customize a customer experience design technique that takes point of view of a customer and focuses on understanding said customer; and
enabling said group to use said customer experience design technique to design said desirable customer experience.

9. The method as recited in claim 8 wherein said enabling said group to use said customer experience design technique to design said desirable customer experience comprises:
identifying a target customer;
determining said desirable customer experience; and
selecting portions of said determined desirable customer experience to implement based on information including feasibility of changes to deliver aspects of said determined desirable customer experience and prioritization of aspects of said determined desirable customer experience

10. The method as recited in claim 9 wherein said determining said desirable customer experience comprises:
determining desires of said target customer at each stage of said customer lifecycle;
determining interactions with said target customer that meet said desires of said target customer; and
determining manner of staying aware of success of said desirable customer experience.

11. The method as recited in claim 9 wherein said selecting portions of said determined desirable customer experience comprises:
determining gap between said determined desirable customer experience and a current customer experience.

12. The method as recited in claim 9 wherein said information further includes competitive differentiator aspects of said determined desirable customer experience.

13. The method as recited in claim 8 wherein stages of said customer lifecycle comprise: awareness, choosing, ordering, installing, learning, using, support/service, and disposing/upgrading.

14. The method as recited in claim 8 wherein said determining current knowledge of said group comprises:
answering questions in a customer data packet submitted to said group.

15. A method of designing desirable customer experiences, said method comprising:
selecting a group of individuals to design a desirable customer experience, wherein said group includes individuals representing each stage of a customer lifecycle, wherein each stage of said customer lifecycle affects said desirable customer experience;
determining current knowledge of said group with respect to said desirable customer experience; and
providing said group a structured set of tools, processes, and templates to design said desirable customer experience, wherein said structured set of tools, processes, and templates is customized based on said current knowledge of said group.

16. The method as recited in claim 15 wherein said providing said group a structured set of tools, processes, and templates to design said desirable customer experience comprises:
identifying a target customer;
determining said desirable customer experience; and
selecting portions of said determined desirable customer experience to implement based on information including feasibility of changes to deliver aspects of said determined desirable customer experience and prioritization of aspects of said determined desirable customer experience

17. The method as recited in claim 16 wherein said determining said desirable customer experience comprises:
determining desires of said target customer at each stage of said customer lifecycle;
determining interactions with said target customer that meet said desires of said target customer; and
determining manner of staying aware of success of said desirable customer experience.

18. The method as recited in claim 16 wherein said selecting portions of said determined desirable customer experience comprises:
determining gap between said determined desirable customer experience and a current customer experience.

19. The method as recited in claim 16 wherein said information further includes competitive differentiator aspects of said determined desirable customer experience.

20. The method as recited in claim 15 wherein stages of said customer lifecycle comprise: awareness, choosing, ordering, installing, learning, using, support/service, and disposing/upgrading.

21. The method as recited in claim 15 wherein said determining current knowledge of said group comprises:
answering questions in a customer data packet submitted to said group.
